(19) United States
(12) Patent Application Publication
(10) Pub. No.: US 2026/0170266 A1
(43) Pub. Date: Jun. 18, 2026

(54) TASK DETECTION IN HETEROGENEOUS QUERIES USING PROMPT PROCESSING UNITS

(71) Applicant: Cisco Technology, Inc., San Jose, CA (US)

(72) Inventors: Frank Bachet, Breval (FR); Marcelo Yannuzzi, Nuvilly (CH)

(73) Assignee: Cisco Technology, Inc., San Jose, CA (US)

(21) Appl. No.: 19/039,608

(22) Filed: Jan. 28, 2025

Related U.S. Application Data
(60) Provisional application No. 63/734,885, filed on Dec. 17, 2024.

(51) Int. Cl. G06F 40/40; G06F 18/2415

(52) U.S. Cl. CPC G06F 40/40; G06F 18/2415

(57) ABSTRACT

In one implementation, a device may split a payload of a prompt for input to a language model into partitions. The device may identify, based on attributes of the partitions, candidate segments of the partitions for modification. The device may generate modified segments of the partitions from a portion of the candidate segments of the partitions. The device may replace the prompt with a revised prompt that includes the modified segments of the partitions.

### RELATED APPLICATION

This application claims priority to U.S. Prov. Appl. Ser. No. 63/734,885, filed Dec. 17, 2024, for TASK DETECTION IN HETEROGENEOUS QUERIES USING PROMPT PROCESSING UNITS by Bachet, et al., the contents of which are incorporated herein by reference.

### TECHNICAL FIELD

The present disclosure relates generally to computer networks, and, more particularly, to task detection in heterogenous queries using prompt processing units.

### BACKGROUND

The use of generative artificial intelligence (GenAI) is helping companies to gradually augment their productivity. For instance, sales, marketing, data analytics, or engineering departments are all increasingly utilizing GenAI, either through pre-trained Large Language Models (LLMs) and/or fine-tuned models and agents.

As companies increasingly leverage GenAI, they face a competing interest of maintaining visibility over and control of how GenAI is being used within the company (e.g., for what kinds of tasks, what data is being involved, what prompts are being used, etc.). Specifically, companies want to segment and control the use of and/or information sent to external LLMs and/or agents.

A first step toward achieving this level of insight and control is to be able to “understand” the information carried in a prompt to an LLM, including any tasks requested to external LLM and/or agents. However, there are no existing approaches able to reliably provide this understanding across the variety and complexity of today's open-end formatted and/or heterogenous LLM prompts.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an architecture for sending prompts to a remote language model;

FIG. 4 illustrates an example of an architecture utilizing prompt processing units;

FIGS. 5A-5B illustrate an example of a prompt input to and a prompt output resulting from the text segmentation and task extraction techniques;

FIG. 6 illustrates an example of an architecture for implementing text segmentation and task extraction techniques;

FIG. 7 illustrates an example of a system variant for task detection in heterogenous queries;

FIG. 8 illustrates an example of another system variant for task detection in heterogenous queries; and

FIG. 9 illustrates an example of a simplified procedure for task detection in heterogenous queries, in accordance with one or more implementations described herein.

### DESCRIPTION OF EXAMPLE IMPLEMENTATIONS

### Overview

According to one or more implementations of the disclosure, a device may split a payload of a prompt for input to a language model into partitions. The device may identify, based on attributes of the partitions, candidate segments of the partitions for modification. The device may generate modified segments of the partitions from a portion of the candidate segments of the partitions. The device may replace the prompt with a revised prompt that includes the modified segments of the partitions.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

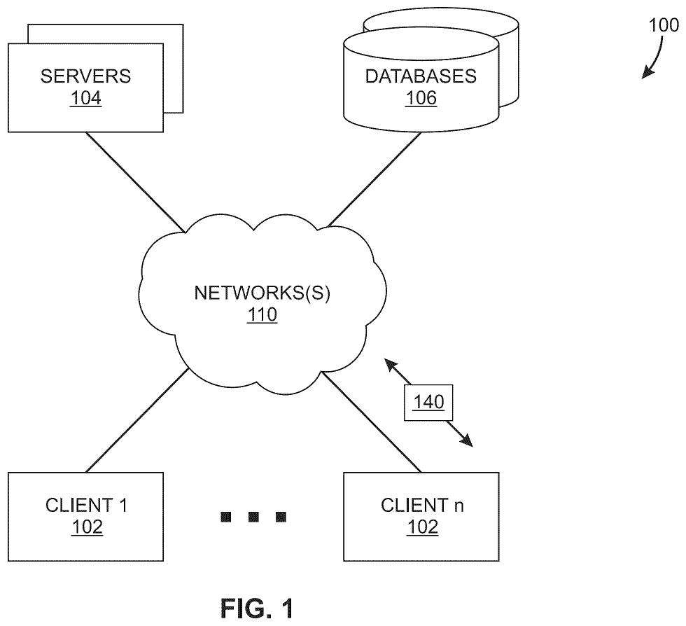

FIG. 1 is a schematic block diagram of an example simplified computing system (e.g., computing system 100) illustratively comprising any number of client devices (e.g., client devices 102 with, e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

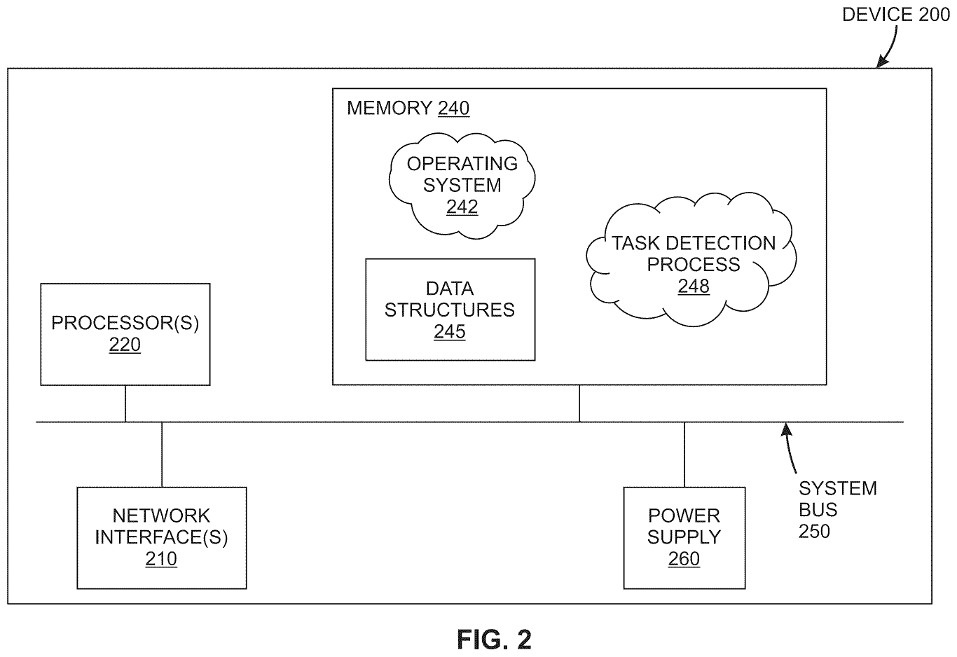

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processes and/or services executing on the device. These software processes and/or services may comprise one or more functional processes, and on certain devices, a task detection process 248, as described herein. Notably, the functional processes, when executed by processor(s) 220, may cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media having computer-executable instructions stored thereon pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, task detection process 248 may include computer executable instructions that, when executed by processor(s) 220, cause device 200 to perform the techniques described herein. For example, task detection process 248 may include computer-executable instructions stored on a computer-readable medium that are executable by processor(s) 220 to cause node/device 200 to perform a portion of a task detection operation in heterogenous queries using prompt processing units.

To do so, in some implementations, task detection process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, task detection process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that task detection process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, task detection process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of prompt analysis, task detection process 248 may use a generative model to dynamically detect and characterize the tasks carried in a prompt, irrespective of the heterogeneity in the formulation of such prompts and the relative placement of the tasks within the prompt's payload. Example generative approaches can include, but are not limited to, generative adversarial networks (GANs), foundation models such as large language models (LLMs), other transformer models, and the like.

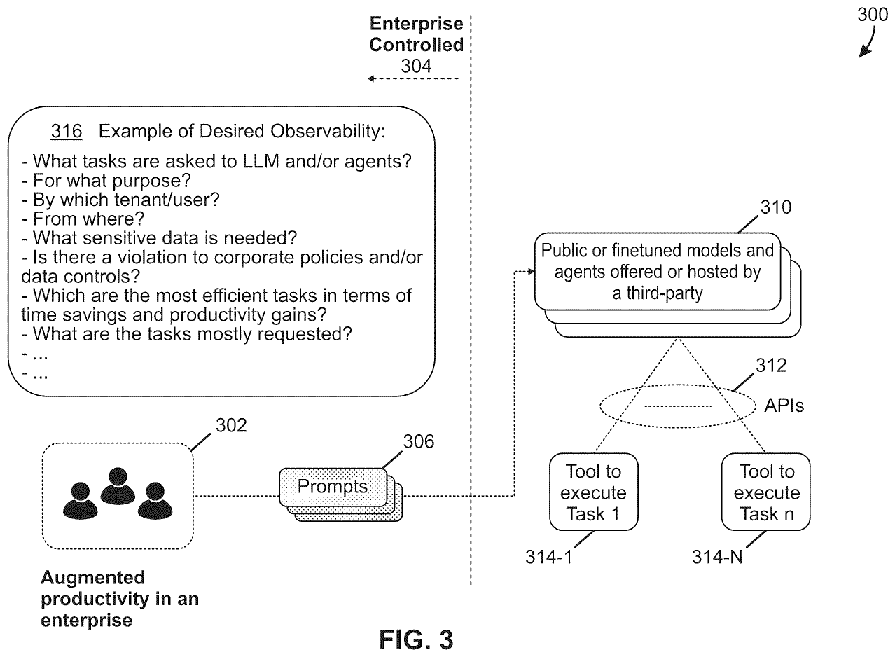

FIG. 3 illustrates an example of an architecture 300 for sending prompts to a remote language model, in various implementations. In architecture 300, users 302 in an enterprise-controlled network may send prompts 306 (e.g., queries, etc.) to an external machine learning model (e.g., machine learning model 310). Typically, prompts 306 may be generated based on input directly from users 302, such as via a chatbot assistant. However, further implementations provide for the use of other programmatic approaches to generate prompts 306, such as by a user selecting a button within a user interface and the underlying program generating a prompt, or the like. In some instances, the executing program may send prompts 306 to machine learning model 310 via one or more application programming interfaces (APIs) and present the results to users 302, accordingly.

Machine learning model 310 may be a public or finetuned language model, such as an LLM, or any other generative AI model configured to process the prompts 306. For example, users 302 such as sales, marketing, customer support, data analytics, engineering, product management, or other personnel in the enterprise may utilize prompts 306 to enhance their productivity.

Although many enterprises aim to leverage generative AI, they may also want to observe what tasks are requested by prompts 306 for performance by machine learning model 310. Additionally, users may want to observe and understand the effectiveness of machine learning model 310 in completing the requested tasks as well as what data is sent, used, and returned by these third-party systems. Consequently, while the prompts 306, users 302, and any corresponding API calls that they may make may be within the enterprise-controlled portion 304, an enterprise may wish to capture observability features 316 to enable more sophisticated controls over the sending of prompts 306 outside the enterprise.

For example, observability features 316 may include the capacity to detect and observe what tasks are requested to external models and/or agents, what sensitive data is needed, or what would be the productivity gain if the task is successfully completed by machine learning model 310. These and other observability features may be enabled, and facilitated, by the disclosed techniques using prompt processing units (PPUs). In addition, tools 314 (e.g., 314-1 . . . 314-N) for executing various tasks may be communicatively coupled (e.g., via APIs 312) to the machine learning model 310 and/or may be operable to participate in the execution of tasks specified in prompts 306.

While many online machine learning models (e.g., ChatGPT, etc.) today are able to interpret open-ended prompts and act upon them by generating artifacts based on such understanding, this skill is also not accessible to the enterprise itself (e.g., within the enterprise-controlled portion 304). This lack of skill hinders the ability to observe and understand the tasks requested by users 302, or what sensitive data would be involved to complete such tasks, and thus, the ability to apply effective controls before prompts 306 are sent to an external entity from that of the enterprise.

However, these features may be enabled, and facilitated, within architecture 300 using prompt processing units (PPUs). Hence, architecture 300 may be modified by incorporating an observability and task detection system that leverages the PPUs. For example, the PPUs may parse a query and/or detect a set of key features from prompts 306 in a systematic manner. The observability and task detection system may then leverage these characterizations to allow for sophisticated controls based on prompt observability and estimated productivity gains.

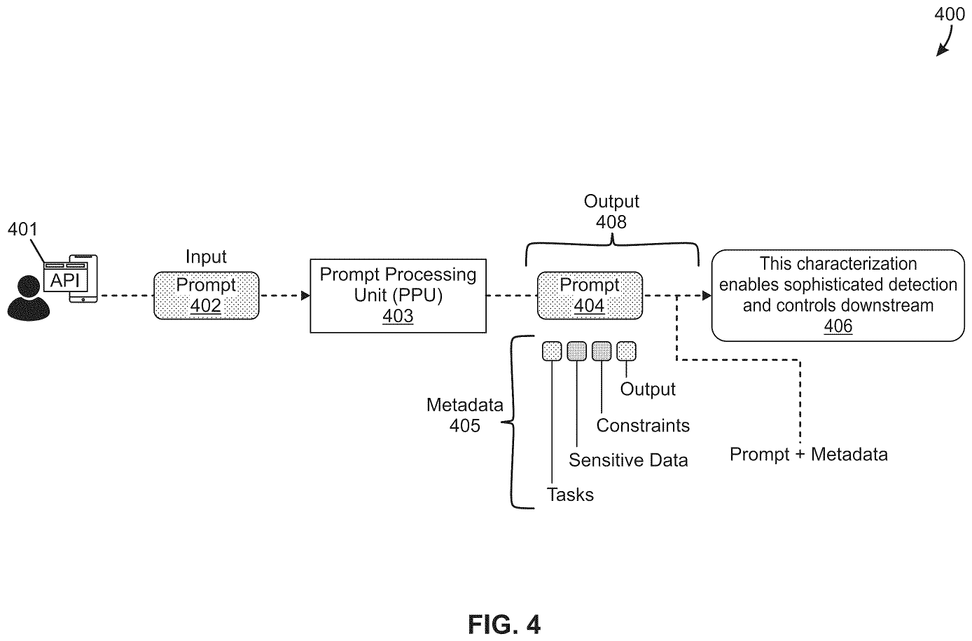

FIG. 4 illustrates an example of an architecture 400 utilizing PPUs, according to various implementations. In some instances, architecture 400 may be a portion of an observability and task detection system that leverages the outputs of PPUs to understand the tasks requested by the users and institute downstream data controls.

As shown, architecture 400 includes a prompt processing unit (PPU 403). A PPU 403 may be a highly efficient processing element that may receive a prompt 402 as an input (e.g., from a user chat interface or an API 401). PPU 403 may parse the query and/or may detect a set of key features from the query carried in a prompt at inference time. For instance, PPU 403 may detect key features within the prompt 402. These may include the class of tasks requested to an LLM (e.g., “Coding Support”), additional details about the class of tasks detected (e.g., “create a python program”), the data needed to complete the tasks (e.g., a snippet of python code), any constraints applicable to carry out the tasks (e.g., “use the code snippet provided”, or “stick to NumPy”), the desired output upon completion of such tasks (e.g., “stdout”), etc.

A PPU 403 may act as a transparent element, delivering the unmodified prompt 404 augmented with metadata 405 carrying the key features, such as those described above. More specifically, a PPU 403 may systematically distill and characterize prompts, allowing for downstream controls 406 to be applied.

As noted above, a first step toward achieving visibility and controls in the use of GenAI is to “understand” the information carried in a prompt, including the tasks requested to external LLMs and/or agents. However, developing PPUs capable of reaching levels of detection and “understanding” that can be used in production poses complex challenges.

A first challenge in achieving this understanding is the nature of modern LLM prompting. These prompts can be created in an open-ended manner, where a human-being or an application, such as a bot or an agent, may freely generate prompts combining various languages, or code related questions jointly with snippets of code, or a request to analyze data that may be appended directly to the prompt, or any combination of them.

Additionally, the tasks requested to an LLM or an agent might be placed anywhere in the prompt payload. For instance, a user may leverage a chat interface to paste raw data, then request to restructure such data and extract a specific part of it, and finally, request to transform and send the data extracted as part of a JavaScript Object Notation (JSON) object using a client Uniform Resource Locator (cURL) provided immediately below.

All of these complexities may be part of a single (long) prompt sent to an LLM or an agent. Indeed, the heterogeneous nature of prompts, where different languages, code, raw data, math formulas and even gibberish text can be mixed and become part of the prompt's payload makes the problem of detecting and “understanding” the tasks requested to an LLM or an agent even harder.

Overall, existing techniques fall short in reliably attaining accurate understandings of today's complex and heterogenous prompts. As a result, companies lack sufficient visibility into GenAI utilization to implement reliable task detection, data controls, and develop accurate understandings of their patterns of use and/or their specific GenAI requirements.

### Task Detection in Heterogenous Queries Using Prompt Processing Units

In contrast, the techniques described herein overcome these challenges by introducing a mechanism for text segmentation and task extraction within a Prompt Processing Unit (PPU). More specifically, the techniques described herein may facilitate a PPU in dynamically detecting and/or characterizing the tasks carried in a prompt, irrespective of the heterogeneity in the formulation of such prompts and the relative placement of the tasks within the prompt's payload.

These techniques may be leveraged with a PPU to dynamically reduce the size of the input prompts and steer the focus onto the main tasks carried in the prompt payload. Hence, the techniques introduced herein may facilitate an enterprise's in automatically identifying and/or characterizing the tasks requested in heterogeneous—and frequently large—prompts, obtaining visibility of those tasks, and/or subsequently applying more effective controls (e.g., before the prompts are processed by external entities like LLMs and/or agents).

Specifically, according to various implementations, a device may split a payload of a prompt for input to a language model into partitions. The device may identify, based on attributes of the partitions, candidate segments of the partitions for modification. The device may generate modified segments of the partitions from a portion of the candidate segments of the partitions. The device may replace the prompt with a revised prompt that includes the modified segments of the partitions.

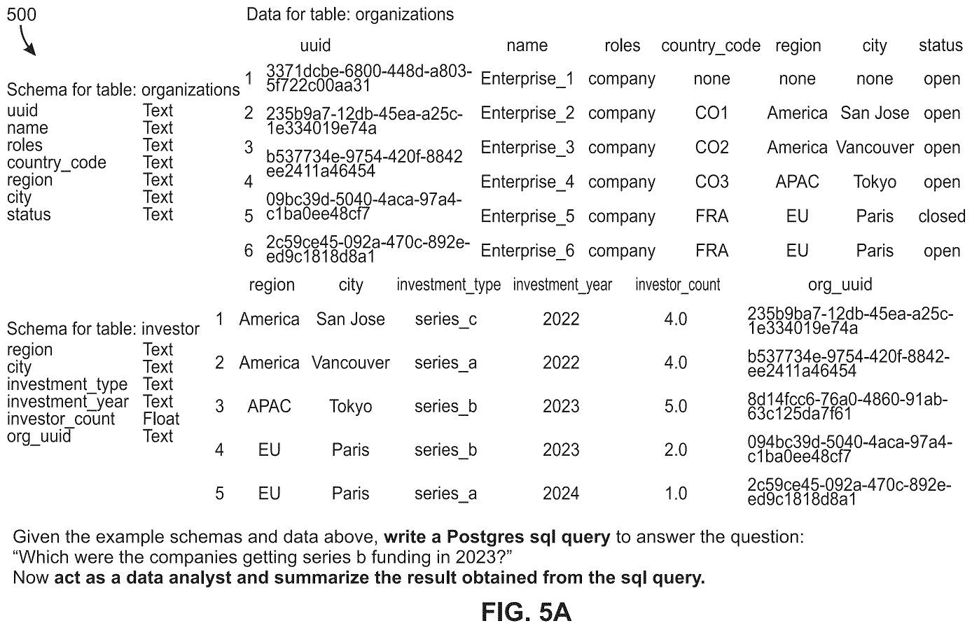

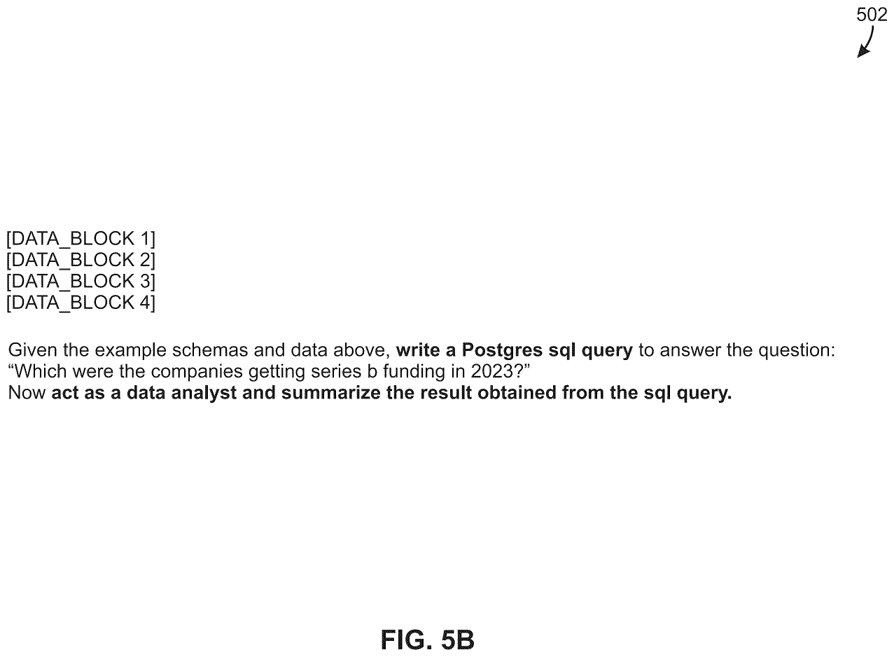

Operationally, FIGS. 5A-5B illustrate an example of a prompt 500 input to and a prompt output 502 resulting from the text segmentation and task extraction techniques outlined herein, in accordance with one or more implementations described herein. As previously noted, a prompt 500 may be long and heterogenous and may include many of the challenging characteristics outlined above. For instance, prompt 500 may start with various types of data captured in a first schema, followed by a table using that first schema, then a second schema followed by another table using the second schema, for which the user may request the following tasks in the same prompt:
“Given the example schemas and data above, write a Postgres sql query to answer the question: ‘Which were the companies getting series b funding in 2023?’. Now act as a data analyst and summarize the result obtained from the SQL query.”

In this example, there are two main tasks requested to a GenAI, namely, “write a Postgres sql query”, and “act as a data analyst and summarize the result obtained from the sql query”. As may be appreciated, the prompts that might be generated and sent to a GenAI can be much more convoluted than prompt 500, and they might be poorly structured and formulated.

This can make the identification and extraction of key characteristics of a prompt, such as the tasks requested to a GenAI, a hard problem to solve. However, application of the task classification and information techniques outlined herein may facilitate achieving an understanding of a complex prompt by a PPU.

For example, a PPU Detection and Segmentation Service component of a PPU may perform operations on prompt 500 including detection, segmentation, labeling, and/or replacement of the data block identified, etc. These operations may be used to generate prompt output 502. The prompt output 502 may then be leveraged by classifier and/or analyzer components of the PPU to identify, classify, and/or extract characteristics (e.g., tasks, task details, data, data references, constraints, desired outputs, etc.) of the prompt 500.

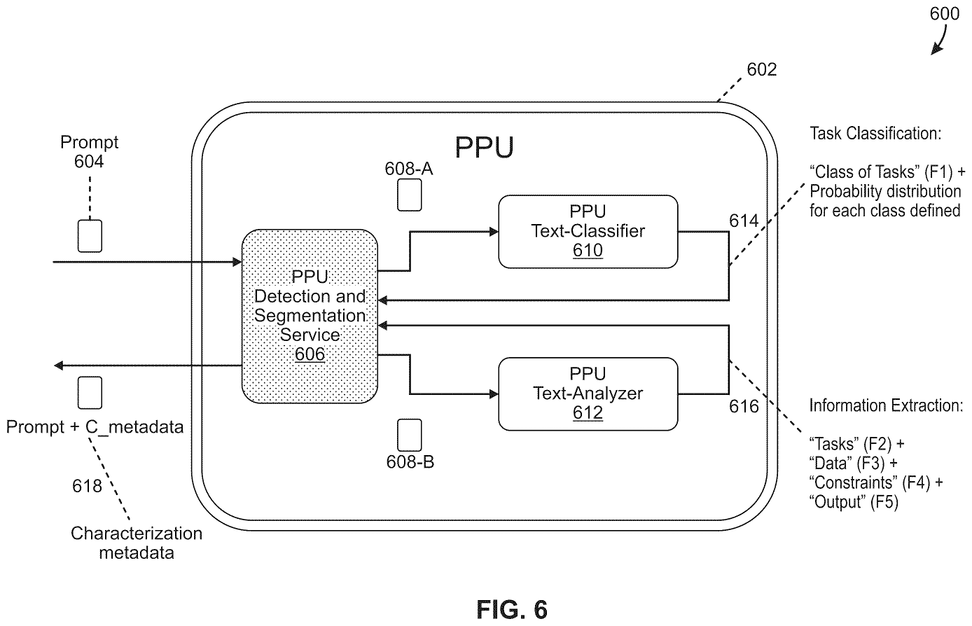

FIG. 6 illustrates an example of an architecture 600 for implementing text segmentation and task extraction techniques facilitated and/or supported using a Prompt Processing Unit (PPU 602). Architecture 600 includes PPU 602, which may be a highly efficient processing element that may receive a prompt 604 as an input (e.g., from a user chat interface or an API), and may process its content to detect a set of features from such a prompt at inference time.

For instance, PPU 602 may be configured to detect and extract various features. Non-limiting examples of these features may include features such as features F1 to F5:
F1. The class of tasks requested to an LLM and/or agent to perform;
F2. Additional details about the class of tasks detected (e.g., the specific tasks requested within a category or class of task);
F3. The data required (if any) to complete such tasks;
F4. Any constraints that may apply for completing the requested tasks; and
F5. The desired output upon completion of such tasks, etc.

These and/or other features may be carried in prompt 604 and may be detected and/or extracted by leveraging various elements within the PPU 602.

For example, this detection and/or extraction may be accomplished by two elements operating in parallel within PPU 602. Namely, a PPU Text-Classifier 610 (e.g., responsible for extracting features such as feature F1 at step 614) and a PPU Text-Analyzer 612 (e.g., responsible for extracting features such as features F2 to F5 at step 616) may be leveraged to identify and/or extract the features carries in the prompt 604.

In order to accurately detect and extract such features, a PPU Detection and Segmentation Service 606, which may be part of PPU 602, may be leveraged. As described above, the payload of prompt 604 may be heterogeneous and/or complex. For instance, the prompt 604 may include: various forms and types of data (e.g., targeting data analysis, etc.); snippets of code (e.g., targeting code debugging, code completion, error explanation, or code optimization, etc.); text in various languages (e.g., part of the request carried in prompt 604 may be to translate certain text, process it, and summarize the outcome, etc.); math formulas; gibberish text; any combination of the above items; etc.

Hence, PPU Detection and Segmentation Service 606 may assist PPU Text-Classifier 610 and PPU Text-Analyzer 612 by detecting, segmenting, labelling, and/or automatically replacing elements in the prompt payload before forwarding them to PPU Text-Classifier 610 and/or PPU Text-Analyzer 612. The PPU Detection and Segmentation Service 606 may forward the operated upon and/or transformed versions of the prompt payload using messages 608-A, and 608-B, respectively. More specifically, PPU Detection and Segmentation Service 606 may detect, segment, label, and dynamically replace any of the items enumerated above, that is, data, code snippets, contents in the prompt in foreign languages (e.g., this may apply for PPUs focused only on English), mathematical formulas, gibberish text, or any combination thereof.

The operations and/or outputs of the PPU Detection and Segmentation Service 606 may increase the accuracy of the classifications, and extractions, performed by PPU Text-Classifier 610, and PPU Text-Analyzer 612, respectively, by focusing the analysis and/or operations of these components on only the parts of the text that matter. For instance, the prompt 604 may be used as an input to PPU Detection and Segmentation Service 606, which may process and deliver identical copies (e.g., as messages 608-A and 608-B) of its output configured to deliver this level of focus to the components downstream within PPU 602.

For example, for the prompt 500 shown in the example in FIG. 5A, the outputs may be represented as copies of the prompt output 502 shown in FIG. 5B. The prompt output 502 may be a revised version of the prompt 500 which is configured to simplify and/or standardize the prompt format to provide a version of the prompt that is focused for further characterization by downstream components.

This approach may ameliorate the complexity, and the semantic confusion inherently involved in the functions performed both by PPU Text-Classifier 610 and PPU Text-Analyzer 612. For example, PPU Detection and Segmentation Service 606 may increase the accuracy of the classifications and metadata extraction by removing parts of text that are not significant for extracting features (e.g., features F1 to F5) from prompt 604. Further, PPU Detection and Segmentation Service 606 may reduce the size, and therefore, the complexity and processing time required by the components downstream, which, as indicated above, may be the ones carrying out the most complex and semantically challenging tasks within PPU 602.

In various implementations, PPU Text-Classifier 610 may operate as a multi-class and/or a multi-label classifier, which may be able to categorize the task(s) requested in prompt 604. The PPU Text-Classifier 610 may categorize the task(s) according to a set of pre-defined categories or classes of tasks. Examples of such classes may include content creation, content processing, text translation, brainstorming, coding support, IT support, data analysis, question answering, conversational, greetings, unintelligible language, missing context, foreign language, gibberish, etc.

PPU Text-Classifier 610 may comprise a Natural Language Inference (NLI) subsystem (e.g., using a model from the DeBERTaV3 family), a relatively small LLM (e.g., phi-3), fine-tuned versions of any of these models, or other models trained from scratch. Alternatively, or additionally, the PPU Text-Classifier 610 may comprise a more elaborated pipeline involving several models operating concurrently, in tandem, or in other arrangements with a twofold objective: i) improve the classification of tasks performed by PPU 602; and ii) make such classifications feasible at inference time. That is, the delays that might be introduced by PPU 602 along with any controls that might take place downstream of PPU 602 (e.g., controls enforced in the hot path using the output of PPU 602 as an input), might be bounded in some cases to a maximum acceptable threshold.

In various implementations, the classification carried out by PPU Text-Classifier 610 may differ. Instead of relying on a set of pre-defined (e.g., human-defined) classes, PPU Text-Classifier 610 may be trained to identify and classify the task(s) carried in prompt 604 without the need to adhere to pre-existing task categories.

PPU Text-Analyzer 612, on the other hand, may support the extraction of concrete tasks (e.g., F2), data (e.g., F3), constraints (e.g., F4) and the desired output (e.g., F5) using Natural Language Processing (NLP) techniques (e.g., by leveraging open-source tools like spaCy). In some instances, the objectives of the “data detections” carried out by PPU Detection and Segmentation Service 606 may differ significantly from those provided by PPU Text-Analyzer 612 as part of feature extraction (e.g., for F3). More specifically, PPU Detection and Segmentation Service 606 may target the identification, segmentation, labeling, and replacement of data elements that would typically be used for data analysis. These may generally be formulated following neither structured nor grammatically intelligible sentences, and therefore, may be predicted as candidates to be replaced by labels aggregating an entire data block, such as [DATA-BLOCK 1] in FIG. 5B.

Instead, PPU Text-Analyzer 612 may use NLP-based techniques for feature extraction, including Part Of Speech (POS) detections and/or Named Entity Recognition (NER). Hence, PPU Text-Analyzer 612 may target to identify and extract (e.g., verbatim) explicit references to data that might be required to complete a task carried in prompt 604.

For example, the specific data-related computations and operations performed by PPU Detection and Segmentation Service 606 might differ from those performed by PPU Text-Analyzer 612. For instance, an example prompt may be: “List the products sold to Drecco Inc. last quarter.” Analysis of the prompt by these components may yield:
the number of data detections by PPU Detection and Segmentation Service 606: NONE;
data related output of PPU Detection and Segmentation Service 606: NONE;
the number of data detections by PPU Text-Analyzer 612: 2;
data related output of PPU Text-Analyzer 612: {Drecco Inc., products sold to Drecco Inc.}.

PPU Text-Analyzer 612 may facilitate feature detection and extraction by utilizing language prediction modules to detect the one or more languages carried in prompt 604. In various implementations, the PPU Text-Analyzer 612 may represent each prompt in a common way (e.g., via a spaCy document) so that it can be tokenized, while capturing grammatical and relevant dependency features. For instance, this common representation may be parsed on a per sentence basis, where the root verb, other verbs, the subject, key terms, and other features might be extracted (e.g., using text rank techniques). This may also include objects and/or attributes such as detecting negative forms, imperative modes, or whether the sentence represents a question. Further, the PPU Text-Analyzer 612 may find candidate tasks within each sentence, which may be split into a root part and additional parts or conditions.

The outputs of PPU Text-Classifier 610 and PPU Text-Analyzer 612 might be sent back to PPU Detection and Segmentation Service 606, which may aggregate the classifications, detections, and extractions made by these elements in the form of metadata. For instance, PPU 602 may generate an output 618 through PPU Detection and Segmentation Service 606, which may make available the original prompt unmodified (e.g., prompt 604 received) along with the prompt characterization (e.g., shown as C_metadata) to various consumers downstream.

In various implementations, PPU 602 may fan-out the original prompt and the corresponding metadata (e.g., output 618) to various controls (or consumers), which may process the output of PPU 602 concurrently and in a non-blocking manner before the prompt is sent to any external entity. Such controls may include security controls, task controls, data controls, model routing controls, etc.

Overall, PPU 602 may act as a transparent element at inference time, delivering the original prompt unmodified, augmented with metadata (e.g., output 618) carrying key features, such as features F1 to F5 above described.

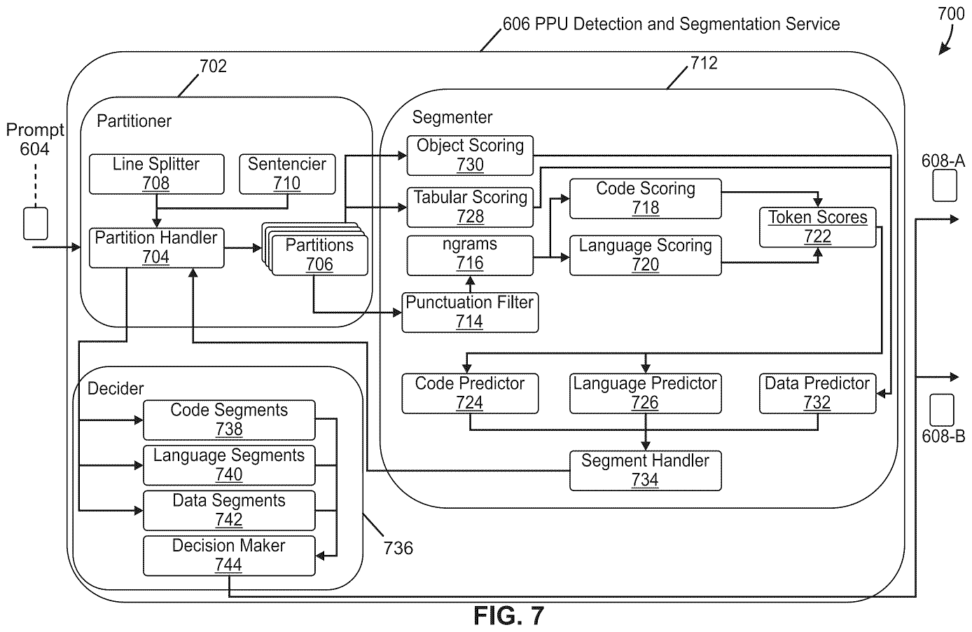

FIG. 7 illustrates an example of a system 700 including a PPU Detection and Segmentation Service 606 configured for task detection in heterogenous queries. The PPU Detection and Segmentation Service 606 may be conceptualized in terms of a series of functional blocks. For example, in various implementations, the PPU Detection and Segmentation Service 606 may be conceptualized as comprising three main functional blocks including a Partitioner 702, a Segmenter 712, and/or a Decider 736. These functional blocks may be operable, as outlined below, to perform the detection and segmentation of language, code, and data blocks.

When prompt 604 is received by PPU Detection and Segmentation Service 606, it may be processed first by Partitioner 702; such as by a Partition Handler 704 element. Partition Handler 704 may split the payload of prompt 604 into a set of partitions (e.g., partitions 706). Several partitions may be generated by Partition Handler 704, and these may be subject to text overlaps among them.

The creation of the partitions 706 may be supported by auxiliary elements such as a Line Splitter 708 and/or a Sentencizer 710 (e.g., spaCy's Sentencizer). In various implementations, Line Splitter 708 may facilitate basic partitioning by creating sections of text focused on a line splitter approach, which might be key for use cases involving data segmentation within a prompt payload.

Sentencizer 710, on the other hand, may rely on a “light” NLP sentencizer tool configured to predict sections as sentences. The term “light” herein may reflect the need to meet certain performance constraints in the hot path, and therefore, use a simplified (e.g., light) sentencizer (e.g., one that lacks grammar and dependency parsers). Overall, Sentencizer 710 may be key for segmenting sentences written in other (e.g., foreign) languages than those supported by a PPU associated with the PPU Detection and Segmentation Service 606.

Segmenter 712 may receive partitions 706 and may act as a segmentation scoring element. For instance, it may apply various techniques for detecting relevant segments (e.g., segments containing other languages, and/or code, and/or data). To this end, partitions 706 may be initially processed by a Punctuation Filter 714, which may remove any punctuation element and convert all partitions 706 into tokens.

The output of Punctuation Filter 714 may be sent to a ngrams component 716. The latter may generate ngrams for the tokens received using a sliding window (e.g., with a default size of three). For instance, if six input tokens are received by ngrams component 716, say A B C D E F, then ngrams component 716 may generate four tuples: (A, B, C), (B, C, D), (C, D, E), (D, E, F).

Then a Language Scoring Component 720 may estimate the languages for each of the ngrams produced by ngrams component 716. The Language Scoring Component 720 may associate the language, and score predicted for each token within a ngram.

Concurrently, a Code Scoring Component 718 may use the output of ngrams component 716 to estimate code attributes for each of the ngrams. Further, Code Scoring Component 718 may predict a score for each token within a ngram (e.g., this may entail detecting valid words in language, reserved coding words, sequences, specific pattern matches, such as “++”, etc.).

Based on this, a Token Scores Component 722 may compile all scores covering both language and code scores for each token. The output of Token Scores Component 722 may now be used by Code Predictor 724 and Language Predictor 726, concurrently. The former may predict code segments using various techniques (e.g., PELT methods for detecting change points, rupture methods, unsupervised techniques, etc.), while the latter may predict language segments leveraging techniques such as binary segmentation.

In parallel, a Tabular Scoring Component 728 and an Object Scoring Component 730 may concurrently process the output of partitions 706. For instance, Tabular Scoring Component 728 may evaluate each partition received as a tabular candidate (e.g., as a CSV match). Similarly, Object Scoring Component 730 may evaluate each partition received as an object (e.g., as a JSON or a YAML match). Indeed, the output of Line Splitter 708, which may be used to generate partitions 706 may facilitate the detection and segmentation of tabular and data objects within Segmenter 712.

The outputs of Tabular Scoring Component 728 and Object Scoring Component 730 may then be used by Data Predictor 732 to predict data segments. The outputs of Code Predictor 724, Language Predictor 726, and Data Predictor 732 may be used as inputs by Segment Handler 734, which may return all the relevant segments detected to Partition Handler 704, so that they can be associated to their corresponding partitions.

Decider 736 may be operable as a decision layer for selecting the best candidate segments per partition using the predictions above described (e.g., specific code segments 738, language segments 740, and data segments 742). Once such selections are made, Decision Maker 744 may facilitate a rebuild of the prompt using the segmented text from the partitions, then label the selected segments detected, and replace the segments for the labels as shown in the example in FIG. 5B (e.g., the replacement may be complete or partial depending on the predictor source and/or the segment coverage in the partition). The final outcome of Decision Maker 744 may now be sent to other elements within the PPU associated with system 700 through messages 608-A and 608-B.

Additional metadata associated to the replaced segments might be added as well. For example, indications of the type of segments replaced, their original size, or other relevant information may be added.

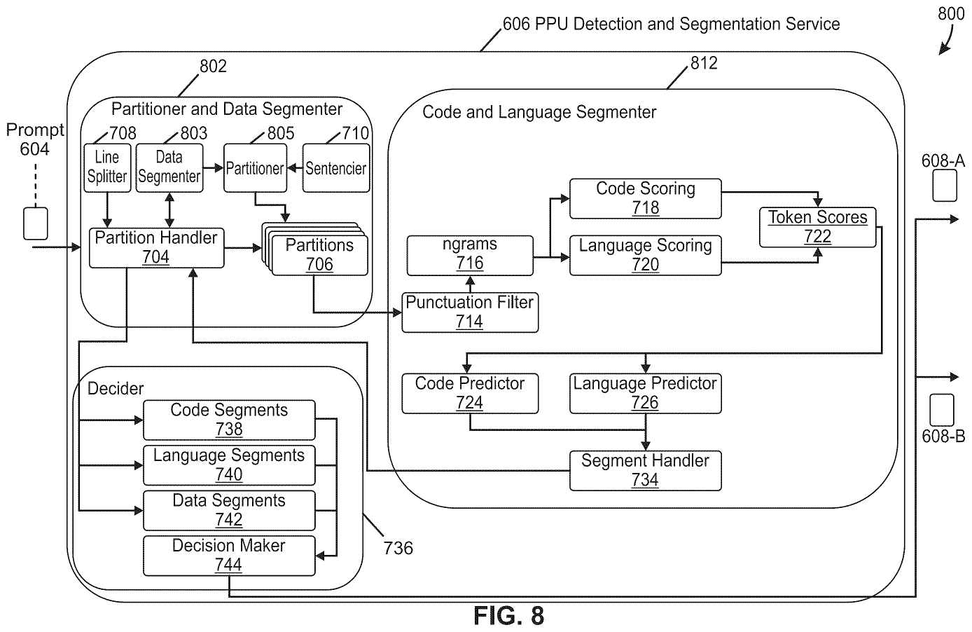

FIG. 8 illustrates an example of a system 800 including an alternative implementation of PPU Detection and Segmentation Service 606 configured for task detection in heterogenous queries. System 800 may operate similarly and/or with similarly components to system 700 described in FIG. 7. However, system 800 may be configured in a manner that significantly reduces the processing time required for large prompts with several data objects (e.g., prompt 500 in FIG. 5A).

System 800 may include a Partitioner and Data Segmenter 802, a Code and Language Segmenter 812, and/or the Decider 736. Here, unlike system 700, the data segmentation part may be part of Partitioner and Data Segmenter 802, instead of being part of a Segmenter component such as Segmenter 712 of FIG. 7. In this case, the data objects in the payload prompt (e.g., in prompt 604) may be replaced by a label using Data Segmenter 803, which may encompass all the data segmentation elements of FIG. 7.

To this end, Partition Handler 704 may also deliver an initial set of partitions, which may serve as an input to Data Segmenter 803. The output of the Data Segmenter 803 may be provided to a partitioner 805 to generate the partitions 706.

The arrangement of system 800 may drastically reduce the number of tokens generated by Punctuation Filter 714, and therefore, the number of ngrams to be processed by the ngrams component 716, thereby reducing the processing time associated to the computation of scores for the ngrams in comparison to system 700, as mentioned above.

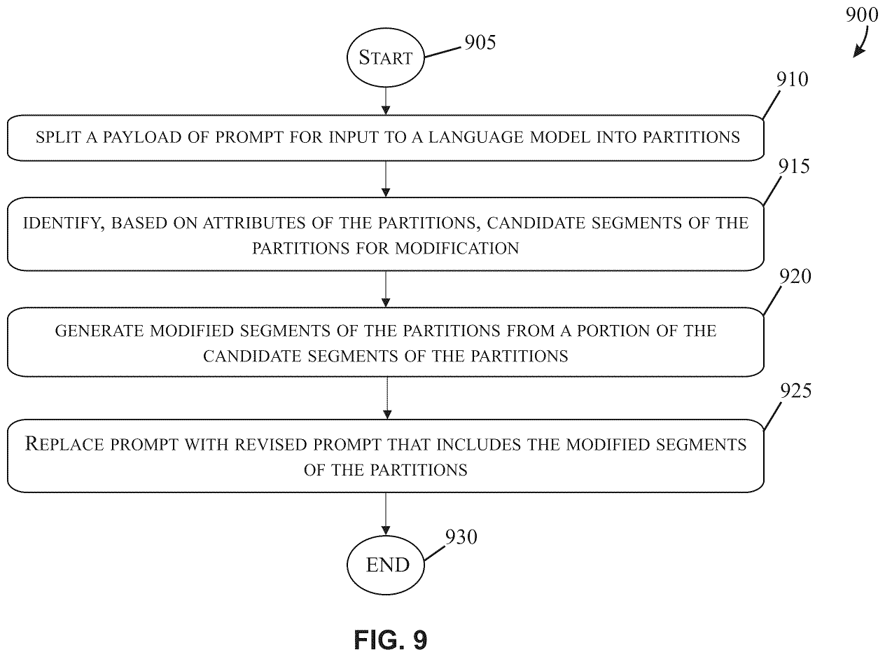

FIG. 9 illustrates an example of a simplified procedure for task detection in heterogenous queries, in accordance with one or more implementations described herein. For example, a non-generic, specifically configured device (e.g., device 200), may perform procedure 900 (e.g., a method) by executing stored instructions (e.g., task detection process 248).

The procedure 900 may start at step 905, and continues to step 910, where, as described in greater detail above, the device (e.g., a controller, processor, etc.) may split a payload of a prompt for input to a language model into partitions. The splitting of the payload of the prompt may be supported by a sentencizer, configured to predict sections of the payload as sentences, and/or by a line splitter that is configured to create sections of text utilizing a line splitting approach.

At step 915, as detailed above, a device may identify, based on attributes of the partitions, candidate segments of the partitions for modification. Identification of the candidate segments may occur through various approaches and/or combinations thereof.

For example, portions of the partitions identified as data segments may be identified as a candidate segment for modification. Identification of these data segments may be based on one or more of a tabular characterization or an object characterization indicating that a segment of a partition is a data segment. For instance, an evaluation may be made of each partition received as a tabular candidate (e.g., as a CSV match) as well as an evaluation of each partition received as an object (e.g., as a JSON or a YAML match). The characterizations resulting from these evaluations may be used to predict which of these segments are data segments and/or are candidate segments for modification.

Likewise, identification of a portion of a partition as a language segment may serve as the basis of a determination whether that portion of the partition is to be identified as a candidate segment for modification. Identification of these language segments may be based on a characterization indicating that a segment of a partition is a language segment. For instance, the partitions may be converted into tokens for which ngrams may be generated. The languages for each of the ngrams may be determined. The determined language and a language score may be associated for each token within a ngram. The characterization may include the language score determined for each token within a ngram converted from a corresponding partition.

Further, identification of a portion of a partition as a code segment may serve as the basis of a determination whether that portion of the partition is to be identified as a candidate segment for modification. Identification of these code segments may be based on a characterization indicating that a segment of a partition is a code segment. As outlined above, the partitions may be converted into tokens for which ngrams may be generated. Code attributes for the output of each of the ngrams may be determined. The determined code attributes and a code score may be associated for each token within a ngram. The characterization may include the code score determined for each token within a ngram converted from a corresponding partition.

At step 920, as detailed above, a device may generate modified segments of the partitions from a portion of the candidate segments of the partitions. Generating the modified segments may include modifying a portion of the candidate segments of the partition in a manner that reduces the size and/or simplifies complexity and/or heterogeneity in the input prompt to steer focus to identification of task features.

For example, the device may generate the modified segments of the partitions by replacing a portion of a candidate segment with a label generated for the candidate segment. That is, the prompt may be rebuilt using the segmented text from the partitions, then the selected segments may be labeled and replaced with those labels. The extent of the replacement (e.g., complete or partial) may be determined based on a predictor source and/or the segment coverage in the partition.

The portion of the candidate segments of the partitions for which the modified segments of the partitions are generated may be selected based on their significance in identifying task classification features for tasks included in the payload of the prompt. For example, the selection of the portion of candidate segments for which modified segments will be generated and/or used as replacements may be based on a determination that the portion of the candidate segments of the partitions are insignificant for determining task classification features for tasks included in the payload of the prompt. For instance, if a portion of a candidate segment is not utilized in extracting task classification features such as the class of tasks requested to an LLM and/or agent to perform, additional details about the class of tasks detected (e.g., the specific tasks requested within a category or class of task), the data required (if any) to complete such tasks, any constraints that may apply for completing the requested tasks, the desired output upon completion of such tasks, etc. then it may be selected as a portion of the candidate segments of the partitions for which the modified segments of the partitions are to be generated and/or used as replacements.

At step 925, as detailed above, the device may generate a revised prompt including the modified segments of the partitions. Copies (e.g., identical) of the revised prompt (as well as, in some instances, metadata associated with the modified segments of the partitions) may then be submitted (e.g., as messages) to feature extraction components. These feature extraction components may be configured to extract task identification features from the revised prompt and/or any accompanying metadata.

The feature extraction components may be utilized to classify, based on the revised prompt including the modified segments of the partitions, tasks included in the payload of the prompt. Classifying the tasks included in the payload of the prompt may include identifying features of the prompt indicative of a task requested in the prompt, a constraint applicable to completing the task, data needed to complete the task, and/or an output of the task.

Procedure 900 then ends at step 930.

It should be noted that while certain steps within procedure 900 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, introduce a technique for prompt processing that can facilitate enterprises in the dynamic detection, characterization, and/or management of tasks and their implicated data within heterogenous and complex prompt payloads. By leveraging text segmentation and task extraction mechanisms, these techniques can be leveraged by a Prompt Processing Unit (PPU) to effectively analyze prompts regardless of their open-ended nature, diverse linguistic structures, or inclusion of mixed context such as code snippets, raw data, mathematical formulas, etc. In many cases this may be done prior to submitting the prompt to an external language model for processing, such that these techniques may be leveraged to provide effective task detection and data controls with respect to what is being sent to the external data model.

For example, the described approaches allow an enterprise system to automatically identify key tasks in a multilingual prompt that incorporates embedded data analysis requests, and/or to isolate and focus processing on core instructions within a prompt containing extraneous or irrelevant material. These capabilities not only provide greater transparency into the tasks and/or data being submitted to external language models or agents but also establish a robust mechanism for implementing controls and governance over sensitive or enterprise-critical information.

As a result, enterprises can leverage the increased visibility and understanding of prompts provided by these techniques to maintain operational oversight and accountability when engaging with external artificial intelligence systems, thereby addressing critical challenges associated with prompt heterogeneity and task invisibility in real-world deployments.

While there have been shown and described illustrative implementations that provide for task detection in heterogenous queries using prompt processing units, it is to be understood that various other adaptations and modifications may be made within the spirit and scope of the implementations herein. For example, while certain implementations are described herein with respect to using certain elements, modules, components, architectures, etc. for the purposes of task detection in heterogenous queries using prompt processing units, the elements, modules, components, architectures, etc. are not limited as such and may be used for other functions, in other arrangements, in other functional distributions, in other implementations, etc. In addition, while certain types of metadata and data types/categories such as tasks, sensitive data, constraints, and outputs are shown, other suitable metadata and data types/categories may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
splitting, by a device, a payload of a prompt for input to a language model into partitions;
identifying, by the device and based on attributes of the partitions, candidate segments of the partitions for modification;
generating, by the device, modified segments of the partitions from a portion of the candidate segments of the partitions; and
replacing, by the device, the prompt with a revised prompt for input to the language model that includes the modified segments of the partitions.

2. The method of claim 1, wherein the device generates the modified segments of the partitions by replacing a portion of a candidate segment with a label generated for the candidate segment.

3. The method of claim 1, further comprising:
identifying, based on one or more of a tabular characterization or an object characterization indicating that a segment of a partition is a data segment, the segment of the partition as a candidate segment for modification.

4. The method of claim 1, further comprising:
classifying, based on the revised prompt including the modified segments of the partitions, tasks included in the payload of the prompt.

5. The method of claim 4, wherein classifying the tasks included in the payload of the prompt includes identifying features of the prompt indicative of one or more of a task requested in the prompt, a constraint applicable to completing the task, data needed to complete the task, or an output of the task.

6. The method of claim 1, further comprising:
identifying, based on a characterization indicating that a segment of a partition is one or more of a code segment or a language segment, whether the segment is a candidate segment for modification.

7. The method of claim 6, wherein the characterization includes a language score determined for each token within a ngram converted from a corresponding partition.

8. The method of claim 6, wherein the characterization includes a code score determined for each token within a ngram converted from a corresponding partition.

9. The method of claim 1, further comprising:
submitting copies of the revised prompt and metadata associated with the modified segments of the partitions to feature extraction components configured to extract task identification features from the revised prompt.

10. The method of claim 1, further comprising:
selecting the portion of the candidate segments of the partitions for which the modified segments of the partitions are generated based on the portion of the candidate segments of the partitions being insignificant for determining task classification features for tasks included in the payload of the prompt.

11. An apparatus, comprising:
one or more network interfaces to communicate with a network;
a processor coupled to the one or more network interfaces and configured to execute one or more processes; and
a memory configured to store a process that is executable by the processor, the process, when executed, configured to:
split a payload of a prompt for input to a language model into partitions;
identify, based on attributes of the partitions, candidate segments of the partitions for modification;
generate modified segments of the partitions from a portion of the candidate segments of the partitions; and
replace the prompt with a revised prompt for input to the language model that includes the modified segments of the partitions.

12. The apparatus as in claim 11, the process further configured to:
generate the modified segments of the partitions by replacing a portion of a candidate segment with a label generated for the candidate segment.

13. The apparatus as in claim 11, the process further configured to:
identify, based on one or more of a tabular characterization or an object characterization indicating that a segment of a partition is a data segment, the segment of the partition as a candidate segment for modification.

14. The apparatus as in claim 11, the process further configured to:
classify, based on the revised prompt including the modified segments of the partitions, tasks included in the payload of the prompt.

15. The apparatus as in claim 14, wherein classification of the tasks included in the payload of the prompt includes identification of features of the prompt indicative of one or more of a task requested in the prompt, a constraint applicable to completing the task, data needed to complete the task, or an output of the task.

16. The apparatus as in claim 11, the process further configured to:
identify, based on a characterization indicating that a segment of a partition is one or more of a code segment or a language segment, whether the segment is a candidate segment for modification.

17. The apparatus as in claim 16, wherein the characterization includes a language score determined for each token within a ngram converted from a corresponding partition.

18. The apparatus as in claim 16, wherein the characterization includes a code score determined for each token within a ngram converted from a corresponding partition.

19. The apparatus as in claim 11, the process further configured to:
submit copies of the revised prompt and metadata associated with the modified segments of the partitions to feature extraction components configured to extract task identification features from the revised prompt.

20. A tangible, non-transitory, computer-readable medium having computer-executable instructions stored thereon that, when executed by a processor on a computer, cause the computer to perform a method comprising:
splitting a payload of a prompt for input to a language model into partitions;
identifying, based on attributes of the partitions, candidate segments of the partitions for modification;
generating modified segments of the partitions from a portion of the candidate segments of the partitions; and
replacing the prompt with a revised prompt for input to the language model that includes the modified segments of the partitions.
